(19) United States
(12) Patent Application Publication
(10) Pub. No.: US 2023/0286712 A1
(43) Pub. Date: Sep. 14, 2023

(54) Tamper-Proof Container

(71) Applicants: Kas Kasravi, West Bloomfield, MI (US); James E. Lucari, Meadow Vista, CA (US); Don D. McCracken, JR., Sacramento, CA (US)

(72) Inventors: Kas Kasravi, West Bloomfield, MI (US); James E. Lucari, Meadow Vista, CA (US); Don D. McCracken, JR., Sacramento, CA (US)

(21) Appl. No.: 17/654,792

(22) Filed: Mar. 14, 2022

(51) Int. Cl. B65D 55/02; B65D 81/20; B65D 51/24; G08B 21/18

(52) U.S. Cl. CPC B65D 55/02; B65D 81/2076; B65D 51/248; G08B 21/182

(57) ABSTRACT

The present invention is a tamper-proof container, which provides secure storage of a valued artifact and optionally destroys the valued artifact if the container is compromised. The core components of the invention are an airtight container comprising a first shell and a second shell, which contains the valued artifact, a gas pressure sensor assembly, a lever assembly, a trigger assembly, a wrecker assembly, and an optional alarm assembly. A predetermined gas pressure is used as the key to protect the container. During the assembly of the container the internal pressure is set to the predetermined container pressure and the container is sealed. If compromised, the change in gas pressure is detected by the gas pressure sensor assembly, which triggers the trigger assembly via the lever assembly, and activates the wrecker assembly to destroy the artifact. Optionally, the trigger assembly activates the alarm assembly to alert the user.

### BACKGROUND OF THE INVENTION

The present invention relates generally to containers, and specifically to a tamper-proof container.

Currently there are a number of solutions for protecting valued artifacts in secure containers. Some of these solutions attempt to provide a safe, protected with a key or a combination lock, but these solutions fail to meet the needs of the industry because the key or the combination lock can be compromised by an offender and the valued artifact obtained. Other solutions attempt to lock down a container to a more secure attachment point by fasteners, but these solutions are similarly unable to meet the needs of the industry because they can be compromised with time and the proper tools. Still other solutions seek to provide alerts in case of tampering, but these solutions also fail to meet industry needs because an alert does not always prevent an offender from taking possession of the valued artifact prior to arrival of those alerted. These various methods of secure containment have their place, but if the artifact's value can be replicated by its owner through other means, and whenever a container is breached it is destroyed, such as with data that can be replicated by its user, the container has thus served its purpose.

It would be desirable to have a tamper-proof container that is impervious to any form of prosperous tampering. Furthermore, it would also be desirable to have a tamper-proof container that would destroy the valued artifact to prevent its value from falling into the wrong hands. Still further, it would be desirable to have a tamper-proof container that would alert those nearby, or remotely via wireless transmission in the event of tampering and optionally mark the valued artifact. Therefore, there currently exists a need in the industry for a tamper-proof container that is impervious to tampering and destroys the valued artifact in case an offender compromises the container.

### SUMMARY OF THE INVENTION

The present invention advantageously fills the aforementioned deficiencies by providing a tamper-proof container, which provides secure storage of a valued artifact and optionally destroys the valued artifact if the tamper-proof container is compromised.

The present invention is a tamper-proof container, which is made up of the following components: a container having a first shell and a second shell, at least one gas pressure sensor, a predetermined container pressure, a trigger assembly, a lever assembly, and a wrecker assembly. These components are related to each other as follows: the tamper-proof container comprises the first shell and the second shell each having inner and outer sides. The tamper-proof container houses the gas pressure sensor, the trigger assembly, and the wrecker assembly. A valued artifact is securely attached to the inner side of the tamper-proof container. During assembly, the inner gas pressure of the tamper-proof container is set to the predetermined container pressure. The gas pressure sensor is calibrated to detect deviation from the predetermined container pressure and triggering the trigger assembly using the lever assembly. Triggering of the trigger assembly activates the wrecker assembly, which destroys the valued artifact. Upon assembly of the aforementioned components the gas pressure inside the container is set to the predetermined container pressure and the tamper-proof container is sealed. When compromised, the change in gas pressure inside the tamper-proof container is detected by the gas pressure sensor, triggering the aforementioned process that leads to destroying the valued artifact.

The present invention may also have one or more of the following: The first shell and the second shell are sealed together using a gasket. The interior of the first shell and the second shell are coated with a self-repairing lining. The gas pressure sensor is an aneroid capsule. The preferred embodiment of the present invention comprises two aneroid capsules, a high-pressure capsule that detects over-stepping the predetermined container pressure, and a low-pressure capsule that detects under-stepping the predetermined container pressure. The high-pressure capsule has a high-pressure activation rod, and the low-pressure capsule has a low-pressure activation rod. Upon detection of a gas pressure change inside the tamper-proof container the aforementioned rods physically trigger the trigger assembly, causing the trigger assembly to activate the wrecker assembly.

The trigger assembly is activated by the rotation of a lever swing rod and a lever trigger rod; the lever swing rod is rotated by engagement of the high-pressure activation rod or; where the lever swing rod is rotated by the engagement of the low-pressure activation rod; the high-pressure activation rod and the low-pressure activation rod are configured to rotate the lever swing rod and the trigger rod in at least one direction, thus activating the trigger assembly when either the high-pressure threshold is over-stepped or the low-pressure threshold is under-stepped; the lever swing rod has a motion dampener to prevent accidental triggering; an optional gasket seals the gap between the first shell and the second shell.

The wrecker assembly has at least one of a harpoon, a screw, a ram, a magnet, an electric discharge, an explosive, or a caustic chemical for destroying the valued artifact; upon activation, the wrecker assembly is energized by at least one of a pre-loaded spring, a pressurized gas cartridge, a chemical reaction, or a rapid electricity generator; the trigger assembly activates an alarm, where the alarm is at least one of a siren or a dye; the alarm is energized by the pressurized gas cartridge; the rapid electricity generator provides power to a wireless transmitter, which transmits a wireless alert.

The present invention is unique when compared with other known devices and solutions because the present invention provides: (1) a tamper detection mechanism is based on gas pressure differential and does not require a key or a combination lock; (2) each tamper-proof container has a different predetermined container pressure, which is not known to others, and therefore not susceptible to compromise by an offender; (3) the valued artifact is destroyed if an offender opens the tamper-proof container; opening the container is detected via the gas pressure sensors and changes in the internal pressure of the tamper-proof container. A change in the tamper-proof container pressure triggers the wrecker and the destruction of the valued artifact; (4) no battery or electricity is used; therefore, the tamper-proof container essentially has a very long useful life; and (5) the valued artifact is permanently protected if the predetermined container pressure is unknown to an offender.

The present invention is unique in that it is structurally different from other known devices or solutions. More specifically, the present invention is unique due to the presence of: (1) an entirely mechanical tamper-proof container with useful life not limited by batteries or electric supply; (2) high-pressure and low-pressure sensors that detect tampering via changes in the internal gas pressure of the sealed container; and (3) at least one modality for the destruction of the valued artifact upon tampering to ensure that the valued artifact never falls into wrong hands.

Among other things, it is an objective of the present invention to provide a tamper-proof container that does not suffer from any of the problems or deficiencies associated with prior solutions.

It is an objective of the present invention to create a permanent tamper-proof container to protect a valued artifact from yielding its value to anyone other than its owner. It is further an objective of the present invention to create a tamper-proof container that is entirely mechanical in operation without its useful life being limited by batteries or other energy sources. It is still further an objective of the present invention to leverage the gas pressure difference between the internal and external space of the tamper-proof container to detect tampering. Further still, it is an objective of the present invention to create a tamper-proof container that is lightweight and easily portable. It is yet an objective of the present invention to destroy the valued artifact upon tampering to prevent it from falling into wrong hands.

The present invention will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF DRAWINGS

FIG. 1 shows a left perspective view of the tamper-proof container.

FIG. 2 shows a perspective view of the gas pressure sensor and the trigger assembly.

FIG. 3 shows a left perspective view of the preferred embodiment of the tamper-proof container.

FIG. 4 shows a perspective view of the bottom of the tamper-proof container and the sealed passage.

FIG. 5 shows a front perspective view of the preferred embodiment of the tamper-proof container.

FIG. 6 shows a right perspective view of the preferred embodiment of the tamper-proof container.

FIG. 7 shows a perspective view of the tamper-proof container and the aneroid capsules.

FIG. 8 shows a perspective view of the tamper-proof container and the lever assembly.

FIG. 9 shows the detailed lever assembly.

FIG. 10 shows an aneroid capsule under normal gas pressure.

FIG. 11 shows an expanded aneroid capsule under low gas pressure.

FIG. 12 shows a compressed aneroid capsule under high gas pressure.

FIG. 13 shows the high-pressure aneroid capsule, the low-pressure aneroid capsule, and lever assembly.

FIG. 14 shows triggering the lever assembly under low pressure condition.

FIG. 15 shows triggering the lever assembly under high pressure condition.

FIG. 16 shows the lever assembly and the trigger assembly.

FIG. 17 shows a triggered level assembly triggering the trigger assembly.

FIG. 18 shows the trigger assembly and the harpoon wrecker.

FIG. 19 shows a triggered harpoon wrecker.

FIG. 20 shows the trigger assembly and the ram wrecker.

FIG. 21 shows the trigger assembly and the magnetic wrecker.

FIG. 22 shows the trigger assembly and an explosive wrecker.

FIG. 23 shows the tamper-proof container with the alarm assembly.

FIG. 24 shows the breakaway notch in the lever trigger rod.

FIG. 25 shows the self-repairing membrane lining on the inner surfaces of the first shell and the second shell.

FIG. 26 shows the pressure chamber containing a tamper-proof container.

FIG. 27 shows the method for assembling and sealing the tamper-proof container.

FIG. 28 shows the method for unsealing and disassembling the tamper-proof container.

### DETAILED DESCRIPTION OF THE INVENTION

The present invention is generally a tamper-proof container for protecting artifacts and more specifically directed at a tamper-proof container that protects a valued artifact for extremely long periods of time without the need for any maintenance. The valued artifact is an artifact that must not fall into the wrong hands, and it would be preferable to have it destroyed than compromised. An example of a valued artifact is a computer memory device or an electronic disc drive containing confidential information.

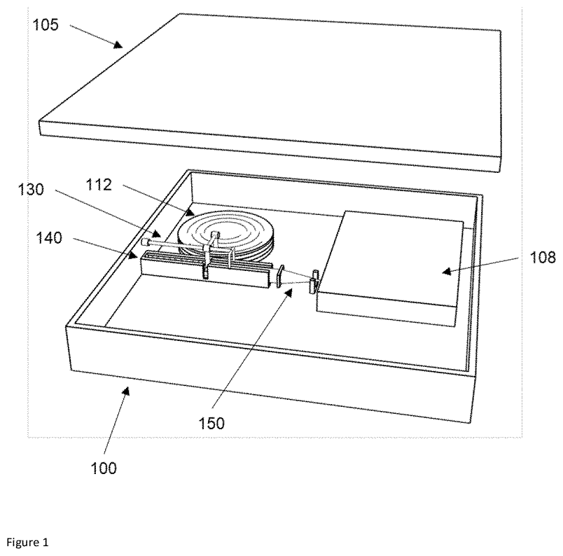

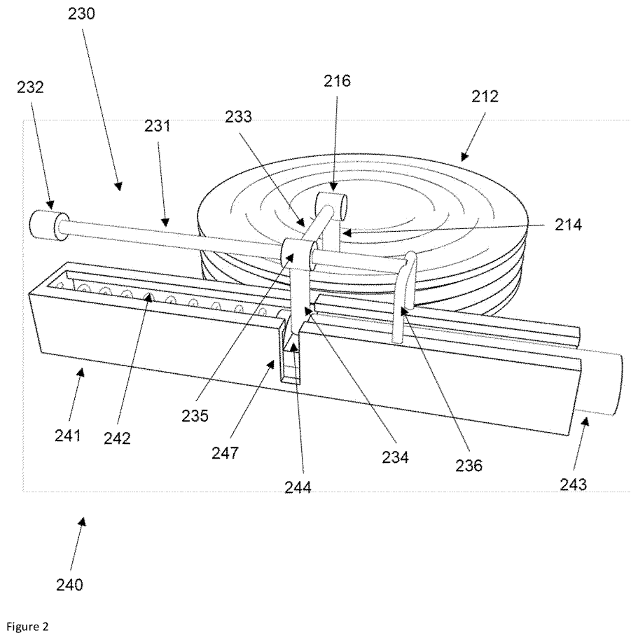

The figures herein follow a numbering convention in which the first digit or digits correspond to the drawing figure number and the remaining digits identify an element or component in the drawing. Similar elements or components between different figures may be identified using similar digits. For example, 145 may reference element “45” in FIG. 1, and a similar element may be referenced as 245 in FIG. 2. Elements shown in the various figures herein can be added, exchanged, and/or eliminated to provide a number of additional examples of the present disclosure. In addition, the proportion and the relative scale of the elements provided in the figures are intended to illustrate the examples of the present disclosure and should not be taken in a limiting sense.

FIG. 1 illustrates the most basic version of the present invention. The tamper-proof container comprises a first shell (100) and a second shell (105), configured to have an inner storage space for the valued artifact (108) and other components. Tampering in the present invention is detected via changes in the gas pressure inside the tamper-proof container after it has been closed. The tamper-proof container is considered closed when the first shell (100) and the second shell (105) are permanently sealed together using processes such as welding, gluing, or fastening. A gas pressure sensor assembly (112) detects changes in the pressure of gas inside the tamper-proof container. The gas inside the tamper-proof container may be air or a specialized gas such as nitrogen. The gas pressure sensor assembly (112) mechanically responds to changes in the gas pressure, activates a lever assembly (130), which triggers a trigger assembly (140). Triggering of the trigger assembly (140) activates a wrecker assembly (150) that destroys the valued artifact (108).

FIG. 2 provides more detail about the triggering mechanism. The gas pressure sensor assembly (212) expands if the pressure of the gas inside the tamper-proof container is reduced and contracts if the said pressure is increased. A gas pressure activation rod (214) is attached to the gas pressure sensor assembly (212) at one end and to a gas pressure activation rod hinge (216) at the other end. The gas pressure activation rod hinge (216) and a lever trigger hinge (235) are connected to each other via a lever swing rod (233). A lever trigger rod (234) is attached to the lever trigger hinge (235). The lever trigger hinge (235) is supported via a lever spine rod (231) which has one end attached to a lever spine hinge (232) and lever support rods (236), both of which are securely attached to the tamper-proof container or other components therein. The aforementioned rods and hinges shown in FIG. 2 cause the lever trigger rod (234) to swing back and forth as the gas pressure activation rod (214) is moved up and down in response to the gas pressure sensor assembly (212) expanding or contracting. A trigger housing notch (247) is an opening in a trigger housing (241) aligned with the lever trigger rod (234) such that the lever trigger rod (234) can freely swing through the said housing.

The trigger assembly (240) is a rigid channel securely attached to the inner surface of the tamper-proof container. Within the channel of the trigger assembly (240) resides a pre-loaded trigger spring (242) and a trigger rod (243). A trigger notch (244) is an opening in the trigger rod (243) such that the lever trigger rod (234) is free to swing in an unobstructed manner. The swinging action of the lever trigger rod (234) releases the pre-loaded trigger spring (242) resulting in the trigger rod (243) rapidly moving forward within the channel of the trigger assembly (240).

A trigger is any device capable of releasing a large amount of energy upon introduction of a small amount of energy. Many forms of triggers are used in firearms, crossbows, spearguns, switches, and quick release locking mechanisms. FIG. 2 shows a preloaded spring that has the potential of forcefully moving the trigger rod (243) when a small amount of energy releases the spring. A person having ordinary skill in the art would recognize that many other forms of trigger can be fabricated and used instead of the trigger assembly (240) shown in FIG. 2. Therefore, the scope of the trigger in the present invention is not limited to the embodiment presented in the figures and encompasses all possible triggers known to a person having ordinary skill in the art. Similarly, the same broad view applies to the lever and the gas pressure sensor.

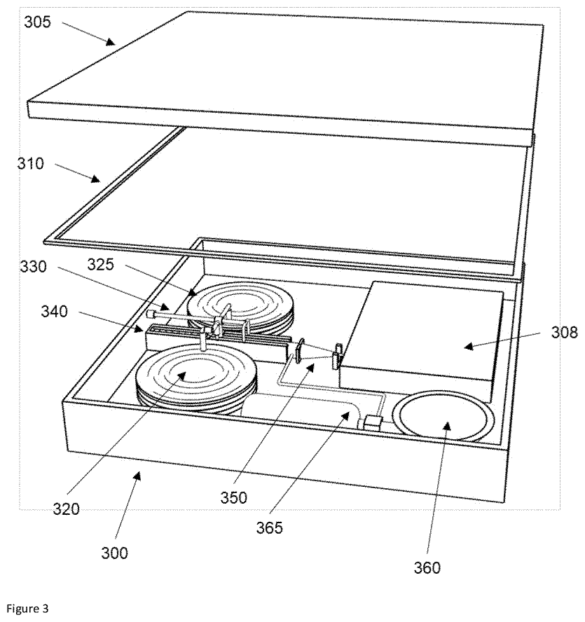

FIG. 3 illustrates a more complete embodiment of the present invention. The first shell (300) serves as the container for the valued artifact (308) and other components. In this embodiment, two gas pressure sensors are used, both of which are aneroid capsules in the preferred embodiment of the present invention. A person having ordinary skill in the art would know that other mechanical means of detecting pressure changes may be used instead of aneroid capsules, without changing the functionality of the present invention. It should also be known to a person having ordinary skill in the art that techniques for miniaturization or enlargement are available and therefore incorporated herein. A high-pressure capsule (320) is an aneroid gas pressure sensor dedicated to sensing high gas pressure within the tamper-proof container. A low-pressure capsule (325) is an aneroid gas pressure sensor dedicated to sensing low gas pressure within the tamper-proof container. Optionally, a predetermined container pressure is used as a secret key; where each tamper-proof container has a secret and unique predetermined container pressure, at which the said capsules are calibrated to be in their natural state. Thus, the said capsules respond when the gas pressure inside the sealed tamper-proof container increases or decreases by a reasonable amount away from the predetermined container pressure; where a reasonable deviation is determined by the tolerances and accuracy of the chosen capsules. A person having ordinary skill in the art would determine the level of gas pressure considered reasonable for each configuration and application. These capsules detect changes in gas pressure within the tamper-proof container, move the lever assembly (330) and trigger the trigger assembly (340) as described earlier. The triggered trigger assembly (340) activates the wrecker assembly (350), which destroys the valued artifact (308). An optional alarm assembly (360) is activated by an alarm (365) when the trigger assembly (340) is triggered, leading to broadcasting an alert. Upon placing and securing the aforementioned components in the first shell (300), the second shell (305) is placed over the first shell (300) and sealed to form the airtight tamper-proof container. An optional gasket (310) is used between the first shell (300) and the second shell (305) to ensure the tamper-proof container is airtight.

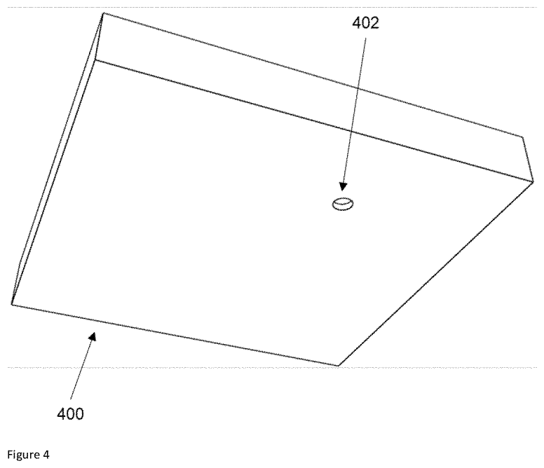

FIG. 4 shows an optional sealed passage (402) on the body of the first shell (400). In certain instances, the aforementioned valued artifact has to connect to external devices via connectors such as wires, cables, hoses, and the like. In such instances a sealed passage (402) allows such connectors to connect the valued artifact to an external device, while the sealed passage (402) is sealed in an airtight manner. The exact location of the sealed passage (402) is dependent on the configuration of the valued artifact. In a similar manner, the sealed passage (402) is optionally located on the second shell (305) shown in FIG. 3.

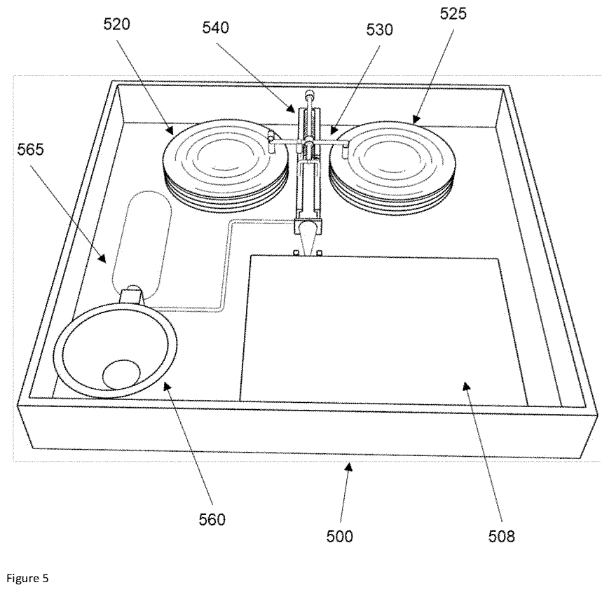

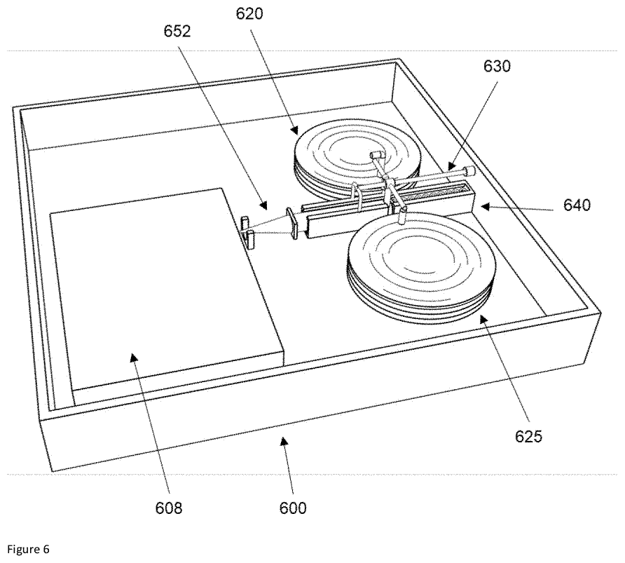

For clarity, FIG. 5 is a front perspective view of the same assembly shown in FIG. 4, where the valued artifact (508), the high-pressure capsule (520), the low-pressure capsule (525), the lever assembly (530), the trigger assembly (540), the optional alarm assembly (560), and the optional alarm (565) are securely placed within the first shell (500). Similarly, FIG. 6 is a right perspective view of the same assembly shown in FIGS. 4 and 5, where the valued artifact (608), the high-pressure capsule (620), the low-pressure capsule (625), the lever assembly (630), and the trigger assembly (640) are securely placed within the first shell (500). The alarm assembly is omitted in FIG. 6 and may be optionally added, if desired.

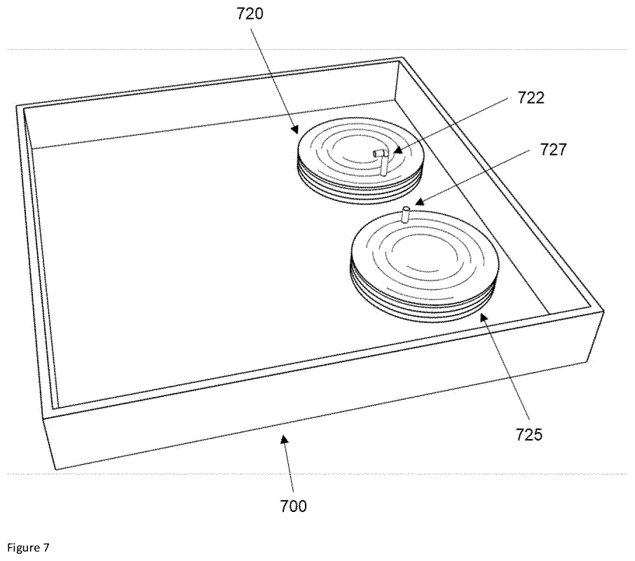

FIG. 7 shows a high-pressure activation rod (722) with its lower end securely attached to the upper surface of the high-pressure capsule (720) relative to the first shell (700). Similarly, FIG. 7 shows a low-pressure activation rod (727) with its lower end securely attached to the upper surface of the low-pressure capsule (725) relative to the first shell (700). These activation rods move up and down with their respective capsules expanding or contracting. The high-pressure activation rod (722) has a hooked upper end as shown. The bottoms of the high-pressure capsule (720) and the low-pressure capsule (725) are securely attached to the first shell (700).

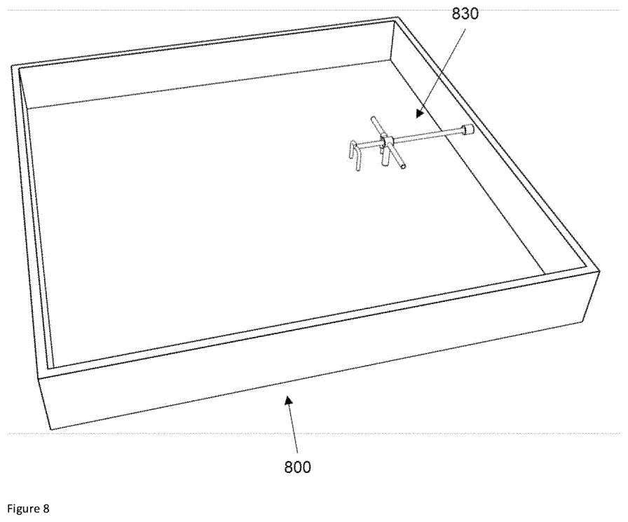

FIG. 8 shows the lever assembly (830) relative to the first shell (800), where the lever assembly (830) is securely attached to the first shell (800).

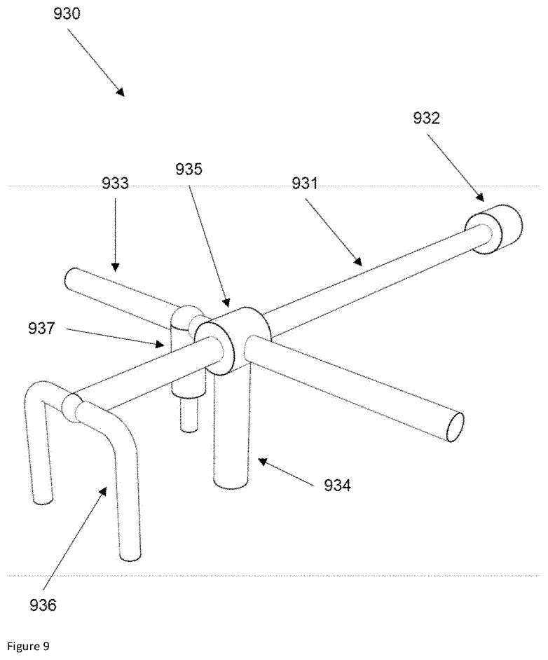

FIG. 9 is a detailed representation of the lever assembly (930). The lever spine hinge (932) is securely attached to the first shell (800) as shown in FIG. 8. The lever spine rod (931) connects the lever spine hinge (932) to the lever support rods (936). The lever swing rod (933) passes through the lever trigger hinge (935) that is attached to the lever spine rod (931). The lever trigger rod (934) is attached to the lever trigger hinge (935) as shown in FIG. 9. The lever swing rod (933) and the lever trigger rod (934) simultaneously swing about the lever spine rod (931) about the lever trigger hinge (935). An optional lever shock absorber (937) is attached to the lever swing rod (933) to prevent accidental movement of the lever swing rod (933). The upper end of the lever shock absorber (937) is attached to the lever swing rod (933) and its lower end is attached to a secure location such as the aforementioned trigger assembly (340) as shown in FIG. 3.

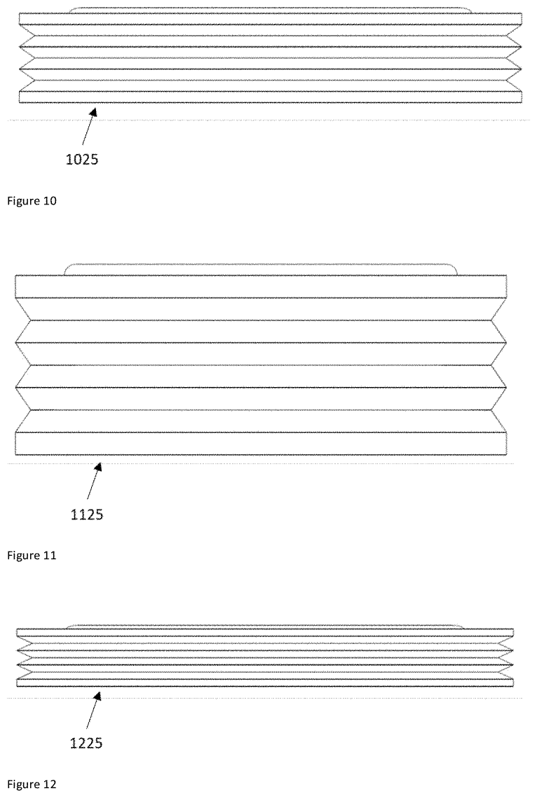

FIG. 10 shows the low-pressure capsule (1025) in its natural state. FIG. 11 shows the low-pressure capsule (1125) in its expanded state when the gas pressure inside the tamper-proof container is lower than expected. FIG. 12 shows the low-pressure capsule (1225) in its contracted state when the gas pressure inside the tamper-proof container is higher than expected. The aforementioned high-pressure capsule would look identical to the low-pressure capsule shown in FIGS. 10, 11, and 12. It is noted that the bottom side of the said capsules are attached to the tamper-proof container and therefore do not move. The upper side of the said capsule move up and down when the capsules are respectively expanded or contracted in response to changes of gas pressure inside the tamper-proof container.

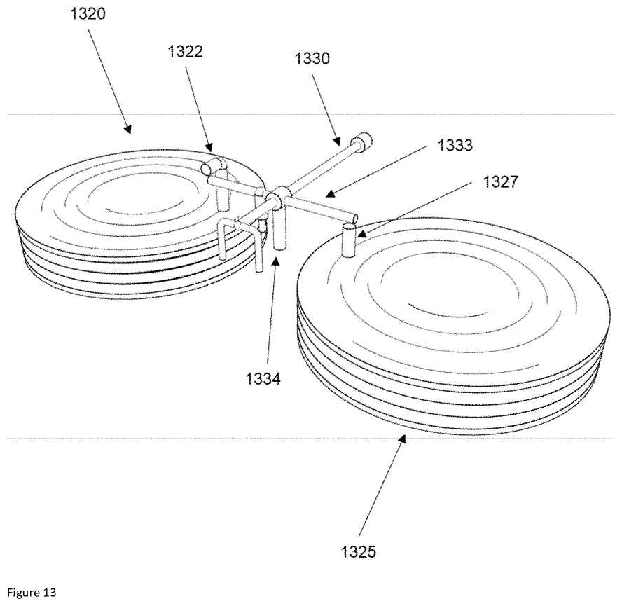

FIG. 13 shows the relationship between the high-pressure capsule (1320), the low-pressure capsule (1325), and the said components of the lever assembly (1330). It is noted that in the preferred embodiment of the present invention the lever trigger rod (1334) swings in the same direction regardless of an increase or decrease in the tamper-proof container's internal pressure. This result comes about because the hook at the top of high-pressure activation rod (1322) pulls down on the said lever swing rod (1333) and the top of the low-pressure activation rod (1327) pushes up against the lever swing rod (1333). The high-pressure activation rod (1322) and the low-pressure activation rod (1327) are optimally located as to not interfere with the movement of the lever swing rod (1333).

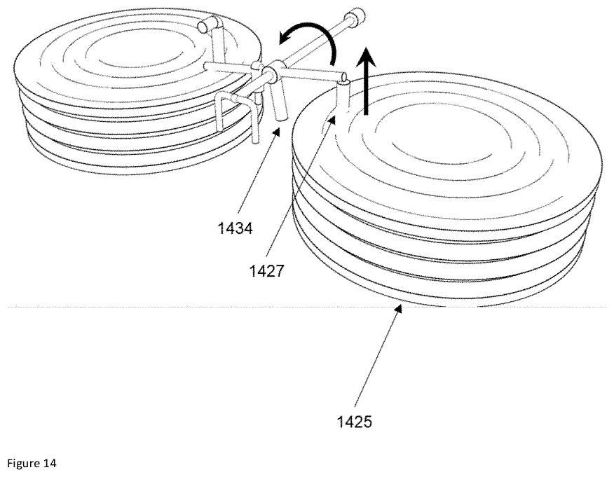

FIG. 14 shows the condition when the tamper-proof container has been compromised and the gas pressure inside the said container has dropped. In this scenario, the low-pressure capsule (1425) expands, pushing the low-pressure activation rod (1427) up resulting in swinging the lever trigger rod (1434) in the direction shown.

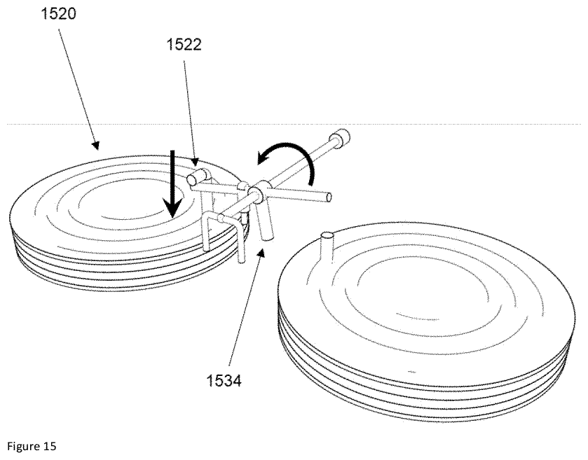

In contrast, FIG. 15 shows the condition when the tamper-proof container has been compromised and the gas pressure inside the said container has increased. In this scenario, the high-pressure capsule (1420) contracts, pulling the high-pressure activation rod (1422) down resulting in swinging the lever trigger rod (1534) in the direction shown. It is noted that the said lever trigger rod swings in the same direction whether the gas pressure inside the tamper-proof container has increased or decreased.

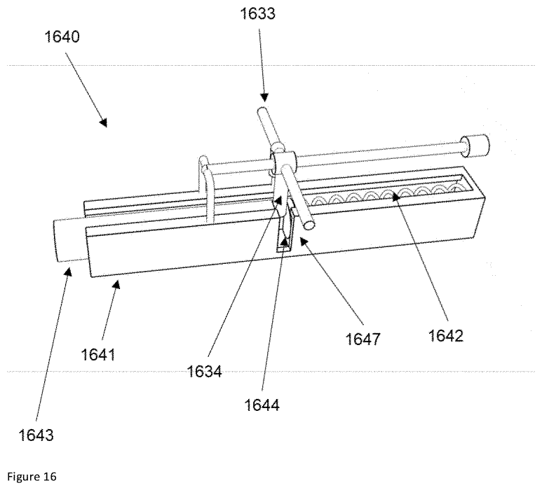

FIG. 16 provides details about the trigger assembly (1640). In the preferred embodiment of the present invention the trigger assembly (1640) comprises trigger housing (1641), the pre-loaded trigger spring (1642), and the trigger rod (1643). The trigger notch (1644) is an opening in the trigger rod (1643) that engages with the lever trigger rod (1634). The trigger housing notch (1647) is an opening in the trigger housing (1641) aligned with the lever trigger rod (1634) such that the lever trigger rod (1634) can freely swing through the said housing. Thus, the swinging action of the lever swing rod (1633) and the lever trigger rod (1634) lead to releasing the trigger rod (1643), which is subsequently pushed forward in a forceful manner by the pre-loaded trigger spring (1642).

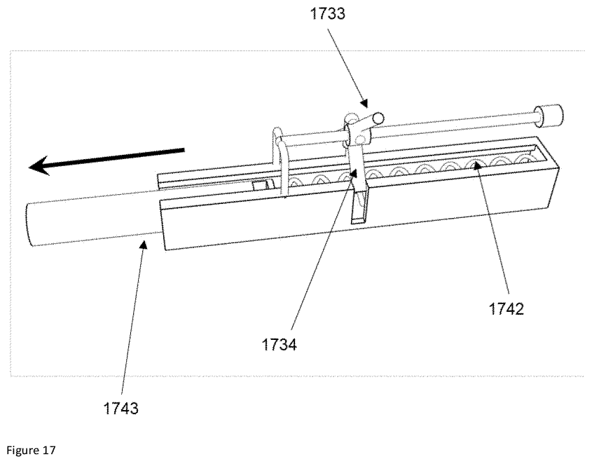

FIG. 17 shows the lever swing rod (1733) and the lever trigger rod (1734) swung out of position, releasing the trigger spring (1742) and pushing the trigger rod (1743) forward in the direction shown.

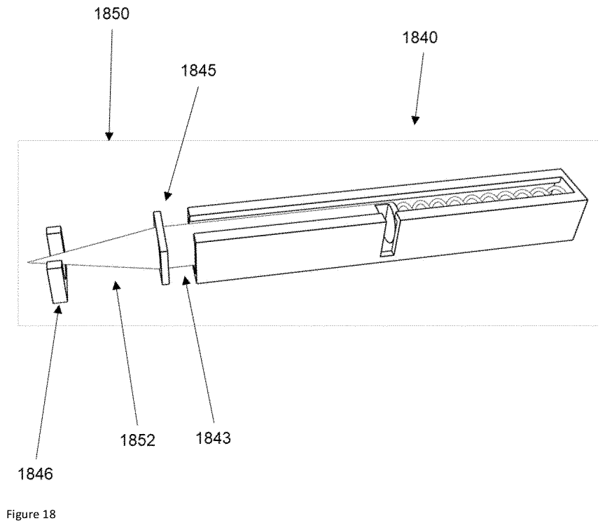

FIG. 18 shows the wrecker assembly (1850) relative to the trigger assembly (1840) and the trigger rod (1843). In this embodiment, the wrecker assembly (1850) comprises a wrecker harpoon (1852), a trigger stop plate (1845), and a trigger stop barrier (1846). The wrecker harpoon (1852) is indicated for scenarios where the said valued artifact can be destroyed via piercing. In such scenarios, and upon activation of the wrecker assembly (1850), the wrecker harpoon (1852) is pushed forward into the said valued artifact causing the valued artifact's destruction. Upon activation of the wrecker assembly (1850), the wrecker harpoon (1852) is pushed forward by the trigger rod (1843) until the trigger stop plate (1845) meets the trigger stop barrier (1846).

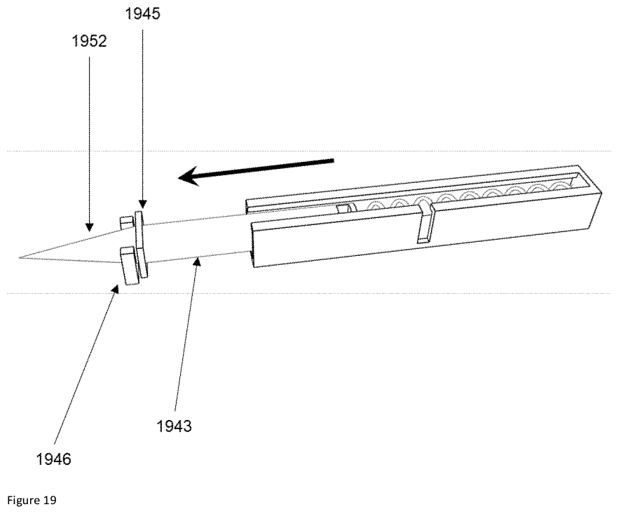

FIG. 19 expands on FIG. 18 by showing how the trigger rod (1943) pushes the wrecker harpoon (1952) forward in the direction shown, until the trigger stop plate (1945) meets the trigger stop barrier (1946).

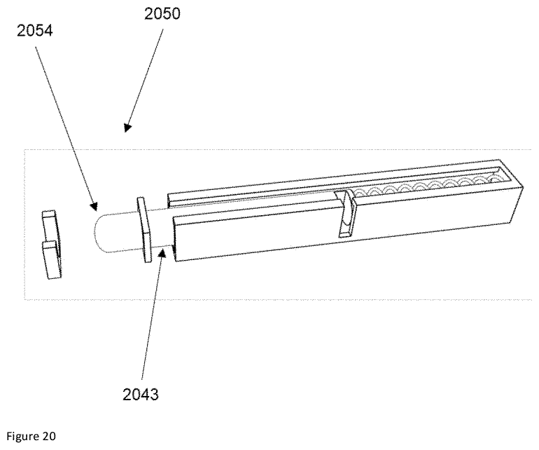

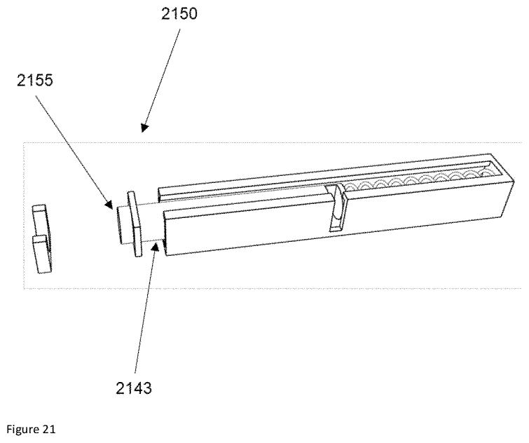

FIG. 20 shows the embodiment where the wrecker assembly (2050) utilizes a wrecker ram (2054) to destroy the said valued artifact when the trigger rod (2043) pushes the wrecker ram (2054) forward. The action of this embodiment is identical to the said wrecker harpoon, except for ramming the said valued artifact instead of piercing it.

FIG. 21 illustrates a different wrecking mechanism where the wrecker assembly (2150) demagnetizes the said valued artifact. In this scenario the trigger rod (2143) pushes forward a wrecker magnet (2155). This embodiment is indicated for scenarios where the valued artifact can be destroyed with a magnet, such as a volatile magnetic data storage module. The operation of this embodiment is identical to the said wrecker harpoon and the said wrecker ram, except that the valued artifact is destroyed via magnetic field energy.

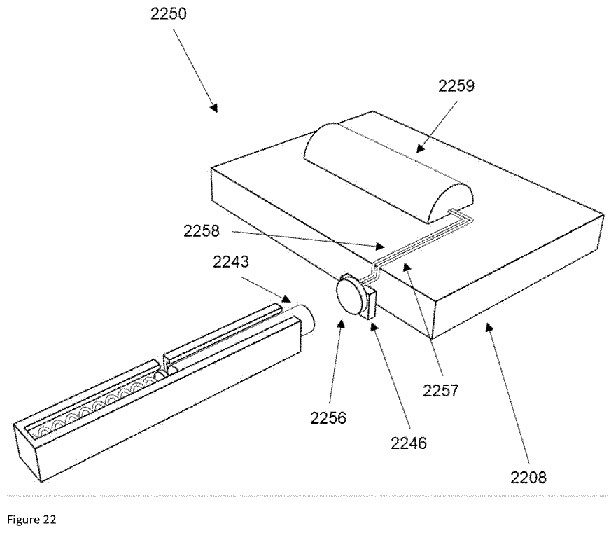

FIG. 22 illustrates a yet different wrecking mechanism, where the wrecker assembly (2250) destroys the valued artifact via an explosion or a micro-explosion. In this embodiment the wrecker assembly (2250) comprises a wrecker piezo (2256) attached to the trigger stop barrier (2246), a first piezo wire (2257), a second piezo wire (2258), and an explosive charge (2259), where the explosive charge (2259) is located in close proximity to the valued artifact (2208). The explosive charge (2259) is fashioned to explode via an electric charge. This embodiment uses the piezo electric effect in the wrecker piezo (2256). The piezo electric effect is known to a person of ordinary skill in the art and well-known in the industry, therefore the concept of piezo electric is not spelled out. But, in general, the piezo electric effect generates a short burst of electricity when physical pressure is applied to a piezo electric device. In this embodiment, upon triggering the trigger rod (2243) applies pressure to the wrecker piezo (2256), which generates a burst of electricity, and the resulting current is transmitted to the explosive charge (2259) via the first piezo wire (2257) and the second piezo wire (2258). The explosive charge (2259) explodes upon receiving the electric charge transmitted by the said piezo wires, causing the destruction of the valued artifact (2208).

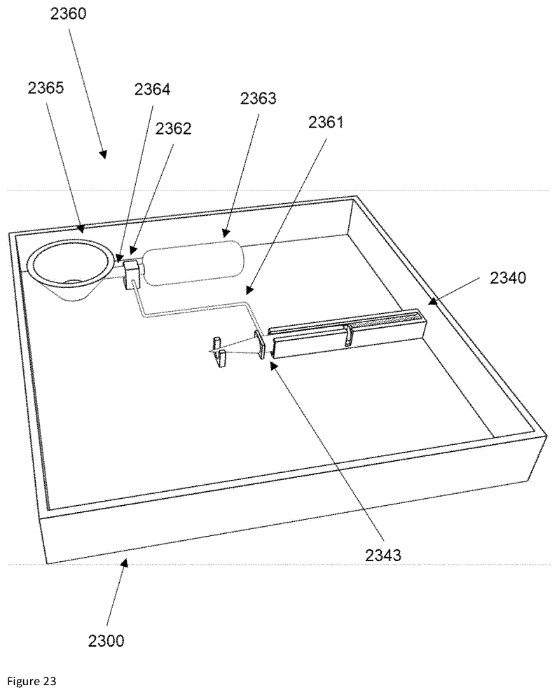

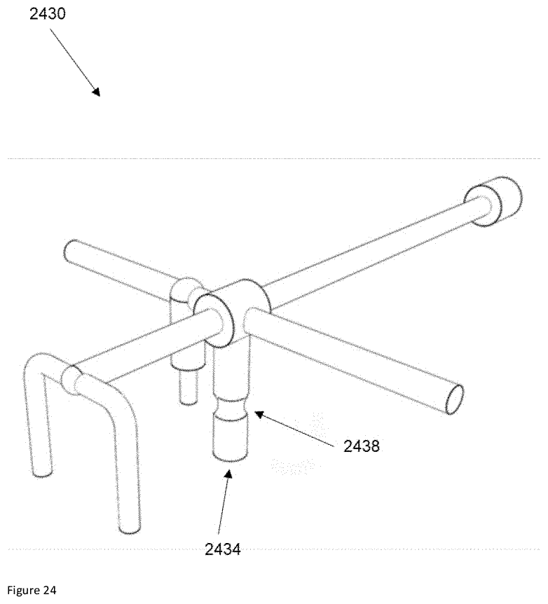

FIG. 23 illustrates an optional embodiment where an alert is desirable. The alert may be in many different forms, such as an audible siren, a dye sprayed over the artifact, or a short wireless communication. The alarm assembly (2360) comprises an alarm rod (2361), an alarm valve (2362), an alarm gas container (2363), and alarm tube (2364), and an alarm (2365). When the trigger assembly (2340) is triggered, the alarm rod (2361) is pushed forward by the action of the trigger rod (2343), which leads to opening the alarm valve (2362) and releasing pressurized gas from the alarm gas container (2363) via the alarm tube (2364) and activating the alarm (2365). A person of ordinary skill in the art would recognize that a similar utility can be obtained using pre-loaded spring, a micro-explosive, or an instantaneous electricity generator to produce a variety of desired alerts, including loud sound, spraying a dye, or broadcasting a wireless message.

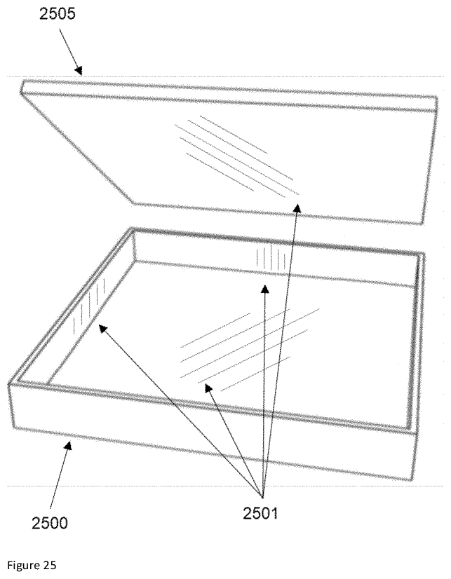

FIG. 24 illustrates the lever assembly (2430) where the lever trigger rod (2434) has a breakaway notch (2438). The breakaway notch (2438) is configured to break away upon rapid shaking or exposure to a high level of vibration, where upon breaking away the lever trigger rod (2434) also break away, thus triggering trigger assembly, activating the wrecker assembly, and destroying the valued artifact. A person having ordinary skill in the art would recognize the dimensions and geometry of the breakaway notch (2438) required for a specific embodiment.

FIG. 25 illustrates the first shell (2500) and the second shell (2505), where the inner surfaces are coated with a self-repairing lining (2501). The self-repairing lining (2501) is formulated to seal any cracks or small holes introduced accidentally or intentionally. If any cracks or small holes are introduced accidentally, the self-repairing lining (2501) prevents accidental destruction of the valued artifact. If the breach was intentional, the self-repairing lining (2501) would maintain the pressure inside the container and prevent the destruction of the valued artifact while not permitting an offender to measure the gas pressure via a small hole in the container. A person having ordinary skill in the art would recognize that a number of different materials and formulations may be used as the self-repairing lining (2501) such as soft cellular polyurethane foam coating or thermally reversible crosslinked polybenzimidazole.

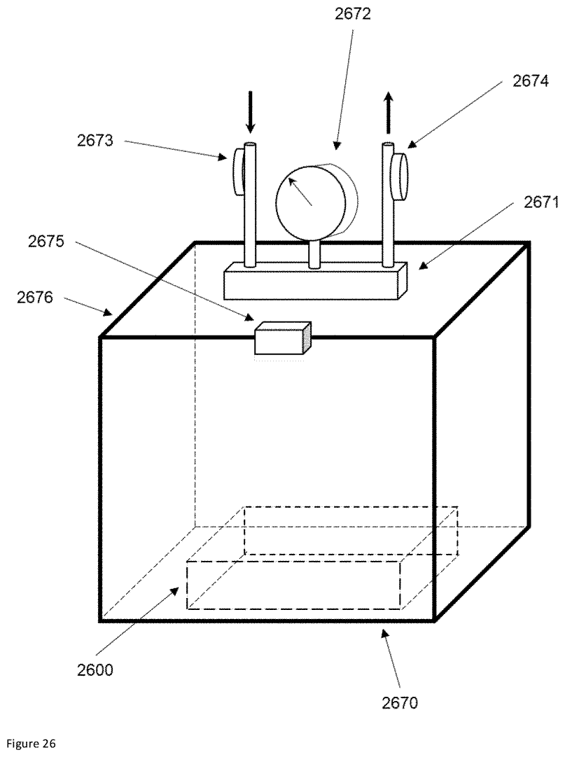

FIG. 26 shows a pressure chamber (2670) used for assembling and optionally disassembling the tamper-proof container (2600) containing the said valued artifact. The pressure-chamber (2670) comprises the plurality of chamber walls (2676) to provide an airtight chamber, a pressure control box (2671), a pressure gage (2672), a gas inlet valve (2673), a gas outlet valve (2674), and a pressure chamber latch (2675). During the assembly or disassembly phases, the tamper-proof container (2600) and the aforementioned assemblies and components are placed within the pressure chamber (2670), the pressure chamber latch (2675) is closed to isolate the pressure inside the said chamber, and gas is either introduced via gas inlet valve (2673) or removed via gas outlet valve (2673) until the pressure gage (2672) indicates the desired predetermined container pressure. The pressure control box (2671) regulates the aforementioned flow and measurement of gas. Upon reaching the predetermined container pressure the tamper-proof container is either assembled or disassembled without triggering the said trigger assembly. Operations inside the pressure chamber (2670) can be robotically controlled, use automation, or conducted manually via airtight gloves.

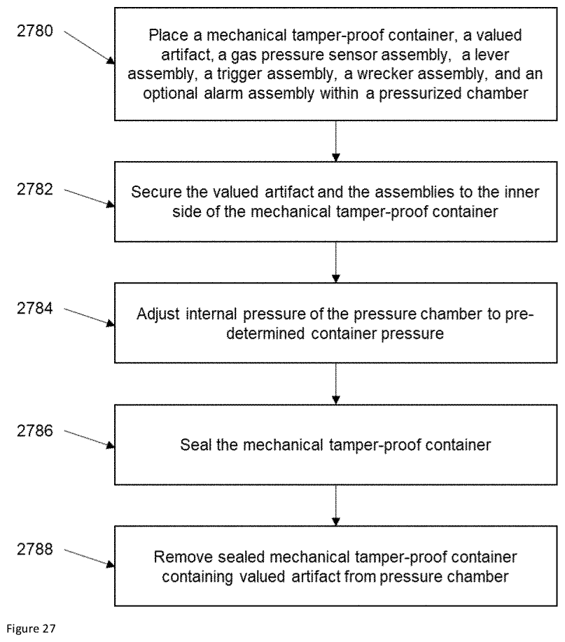

FIG. 27 shows the method for assembling the tamper-proof container. In step 2780 the tamper-proof container, the valued artifact, and all the aforementioned assemblies are placed inside the pressure chamber. In step 2782 the valued artifact and the aforementioned assemblies are secured in place. In step 2784 the internal pressure of the pressure chamber is set to the secret and unique predetermined container pressure. The assembly of pressure sensing components is kept within design tolerances of the secret predetermined container pressure used in this step. In step 2786 the tamper-proof container is sealed airtight by securing the said first shell against the said second shell. In step 2788, the pressure inside the pressure chamber is normalized and the tamper-proof container is removed from the pressure chamber.

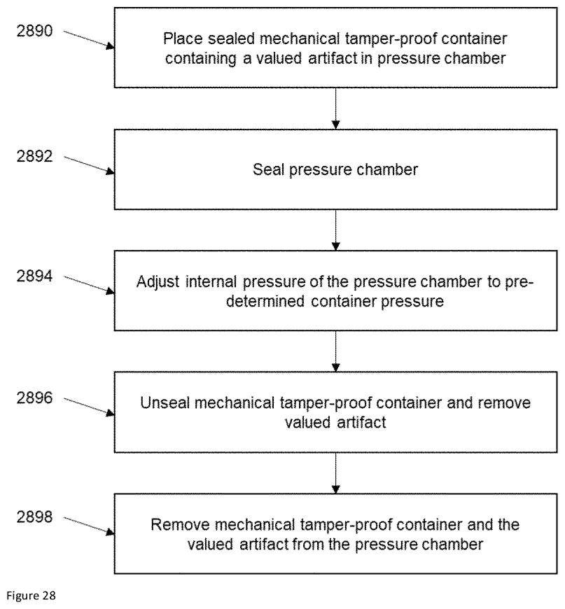

FIG. 28 shows the optional method for disassembling the tamper-proof container. This scenario is relevant if it is desired to remove the valued artifact from the tamper-proof container. If not, the secret predetermined container pressure is destroyed after assembly, and it would be impossible to remove the valued artifact without destroying it. If the removal of the valued artifact is desired, then the secret predetermined container pressure is securely stored and used during the following disassembly process. In step 2890 the sealed tamper-proof container is placed within the pressure chamber. In step 2892 the pressure chamber is sealed. In step 2894 the internal pressure of the pressure chamber is set to the predetermined container pressure. In step 2896 the tamper-proof container is opened, and the value artifact is removed. At this stage, the said trigger assembly will not trigger because the container pressure does not change. In step 2898 the valued artifact, the tamper-proof container and the aforementioned assemblies are removed from the pressure chamber.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A tamper-proof container comprising:
an airtight container comprising a first shell and a second shell having inner and outer sides, fashioned to securely contain a valued artifact, where the first shell and the second shell are solid;
at least one gas pressure sensor assembly securely located inside the airtight container, comprising a gas pressure sensor and a gas pressure activation rod, where the gas pressure sensor is mechanical;
a lever assembly securely located inside the airtight container and connected to the gas pressure activation rod;
a trigger assembly securely located inside the airtight container and connected to the lever assembly;
a wrecker assembly securely located inside the airtight container and connected to the trigger assembly, where the wrecker assembly is positioned such that upon activation it the wrecker assembly destroys the valued artifact; and
a predetermined container pressure lower than atmospheric pressure within the airtight container, where the gas pressure sensor assembly responds to an increase in the predetermined container pressure and triggers the destruction of the valued artifact via the trigger assembly and the wrecker assembly.

2. The tamper-proof container of claim 1, where the wrecker is at least one of a harpoon, a screw, a magnet, an electric discharge, an explosive, and a caustic chemical.

3. The tamper-proof container of claim 2, where upon triggering the wrecker is energized by at least one of a pre-loaded spring, a pressurized gas cartridge, a chemical reaction, and a rapid electricity generator.

4. The tamper-proof container of claim 3, where the gas pressure sensor assembly comprises a high-pressure capsule with a high-pressure activation rod, and a low-pressure capsule with a low-pressure activation rod.

5. The tamper-proof container of claim 4, where the high-pressure capsule detects the gas pressure inside the airtight container when above the predetermined container pressure.

6. The tamper-proof container of claim 5, where the low-pressure capsule detects the gas pressure inside the airtight container when below the predetermined container pressure.

7. The tamper-proof container of claim 6, where the trigger lever has a motion dampener.

8. The tamper-proof container of claim 7, where an airtight gasket seals the gap between the first shell and the second shell.

9. The tamper-proof container of claim 8, where the airtight container has a sealed passage providing a connection route between the valued artifact and a device external to the airtight container.

10. The tamper-proof container of claim 8, where the lever assembly has a breakaway notch.

11. The tamper-proof container of claim 8, where the inner surfaces of the first shell and the second shell are coated with a self-repairing lining.

12. The tamper-proof container of claim 8, where the trigger activates an alarm.

13. The tamper-proof container of claim 12, where the alarm is at least one of a siren and a dye.

14. The tamper-proof container of claim 13, where the alarm is energized by the pressurized gas cartridge.

15. The tamper-proof container of claim 13, where a rapid electricity generator provides power to a wireless transmitter, which transmits a wireless alert.

16. A method for assembling a tamper-proof container comprising:
placing a tamper-proof container, a valued artifact, a gas pressure sensor assembly, a lever assembly, a trigger assembly, a wrecker assembly, and an optional alarm assembly within a pressurized chamber;
securely attaching the valued artifact, the gas pressure sensor assembly, the lever assembly, the trigger assembly, and the wrecker assembly with the tamper-proof container;
adjusting the pressure within the pressurized chamber to a predetermined container pressure;
sealing the tamper-proof container; and
removing the tamper-proof container from the pressurized chamber.

17. A method for disassembling a tamper-proof container comprising:
placing a tamper-proof container containing a valued artifact within a pressurized chamber;
adjusting the pressure within the pressurized chamber to a predetermined container pressure;
opening the tamper-proof container;
removing the valued artifact from the tamper-proof container;
removing the valued artifact and the tamper-proof container from the pressurized chamber.
